(19) United States
(12) Patent Application Publication
(10) Pub. No.: US 2017/0192645 A1
(43) Pub. Date: Jul. 6, 2017

(54) SYSTEM AND METHOD FOR STORING AND SEARCHING DIGITAL MEDIA

(71) Applicants: Brad Murray, Pennington, NJ (US); Albert Glenn Paul, Titusville, NJ (US)

(72) Inventors: Brad Murray, Pennington, NJ (US); Albert Glenn Paul, Titusville, NJ (US)

(21) Appl. No.: 14/989,164

(22) Filed: Jan. 6, 2016

(51) Int. Cl. G06F 3/0481; H04N 5/44; H04N 5/232; G06F 17/30; G06F 17/22

(52) U.S. Cl. CPC G06F 3/04817; G06F 17/3033; G06F 17/2247; H04N 5/23293; H04N 5/44

(57) ABSTRACT

A digital media management system is provided which includes a server configured to receive media from a plurality of wireless devices via a network. The server includes a metadata interpreter, a media database, and a web interface component. The metadata interpreter is configured to receive metadata associated with the received media, where the metadata includes time and location data. The media database is configured to store a plurality of media and its associated metadata. The web interface component is configured to automatically generate a display of media based upon time and location ranges corresponding to the associated metadata.

### CROSS-REFERENCE TO RELATED APPLICATIONS

This application claims priority to provisional applications 62/100,453, filed on Jan. 6, 2015, which is herein incorporated by reference.

### FIELD OF THE INVENTION

Embodiments of the present invention relate generally to media distribution systems, and more particularly, to automatically organizing collections of media.

### BACKGROUND OF THE INVENTION

There has been an unprecedented boom in the popularity of amateur camerawork sparked by the widespread adoption of mobile technology that incorporates cameras, either for pictures or video. Mobile phone manufacturers have supplanted traditional camera companies as the world's largest producers of cameras. Software development companies have responded to this boom by creating media applications that allow users of mobile phones to manipulate, view, and share media in creative ways.

Online media sharing typically requires a multi-step process including capturing a photo or video on a wireless device, uploading the photo or video, establishing a social network of acquaintances to allow to view the photo or video, and sending an invitation or identifying the photo or video so that invitees may view the photo or video. Photos or video are typically captured at events where attendees may not know each other, but wish to create a collection of media together, such as wedding invitees. The typical process of creating a collection of shared event media requires downloading and installing an application, publishing the images with a hashtag and a unique character string, communicating the hashtag and character string to attendees of an event, and searching for that precise hashtag and character string.

An example of such a process is illustrated in U.S. Pat. No. 9,113,301, issued to Spiegel et al., which is herein incorporated by reference. The process includes receiving a message and geo-location data for a device sending the message, determining whether the geo-location data corresponds to a geo-location fence associated with an event, and posting to an event gallery associated with the event when the geo-location data corresponds to the geo-location fence associated with the event. However, this and similar processes require a registration request for a particular group or event, either an explicit request to join a group or follow an event, or a triggered request to register based on geo-location data.

Requiring registration can cause a significant delay as viewers and sharers wait for acceptance to a group or event. Participants must additionally wait for a group or event to be created and published so that they may join and search for media. Further, organizational time, thought, and cost must be spent on sharing event media such as a particular hashtag or character string to define the event. Typically, attendees of an event may receive an email a week or longer afterwards with links to photos or video that the event organizers assembled. However, attendees often lose interest by that time. If the event does not have an organizer, then no one will gather media to share with the attendees.

Thus, there is a need for a system configured to address these and other shortcomings of the current systems.

### SUMMARY OF THE INVENTION

According to some embodiments, a digital media management system is provided. The digital media management system includes a server configured to receive media from a plurality of wireless devices via a network. The server includes a metadata interpreter, a media database, and a web interface component. The metadata interpreter is configured to receive metadata associated with the received media, where the metadata includes time and location data. The media database is configured to store a plurality of media and its associated metadata. The web interface component is configured to automatically generate a display of media based upon time and location ranges corresponding to the associated metadata.

According to some embodiments, a method for digital media management is provided. The method includes the steps of receiving media and associated metadata from a plurality of wireless devices, where the metadata includes time and location data; storing the plurality of media and its associated metadata in a database; and automatically generating a display of media based upon time and location ranges corresponding to the associated metadata.

According to some embodiments, a digital media management system is provided. The digital media management system includes a server configured for receiving media, where the server includes a metadata interpreter and a media database. The metadata interpreter is configured to receive metadata associated with the received media, where the metadata includes time and location data. The media database is configured to store a plurality of media and its associated metadata. The digital media management system further includes a plurality of wireless devices configured for transmitting media, where each wireless device includes a camera and a web interface component. The web interface component is configured to automatically generate a display of media based upon time and location ranges corresponding to the associated metadata. The digital media management system further includes a network for which to transmit and receive media.

Various other features and advantages will be made apparent from the following detailed description and the drawings.

### BRIEF DESCRIPTION OF THE DRAWINGS

In order for the advantages of the invention to be readily understood, a more particular description of the invention briefly described above will be rendered by reference to specific embodiments that are illustrated in the appended drawings. Understanding that these drawings depict only exemplary embodiments of the invention and are not, therefore, to be considered to be limiting its scope, the invention will be described and explained with additional specificity and detail through the use of the accompanying drawings, in which:

FIG. 1 is a block diagram of a digital media management system in accordance with an embodiment of the present invention;

FIG. 2 is a sample home page of a web interface to the digital media management system in accordance with an embodiment of the present invention;

FIG. 3 is a sample screen shot of a wireless device camera prior to capturing an image in accordance with an embodiment of the present invention;

FIG. 4 is an approval screen allowing a user to approve or discard captured media in accordance with an embodiment of the present invention;

FIG. 5 is a sample screen shot of a web interface showing search results on a web site in accordance with an embodiment of the present invention;

FIG. 6 is a sample screen shot of a web interface showing an implementation of a search page in accordance with an embodiment of the present invention;

FIG. 7a is a flow chart illustrating the process of accumulating images and metadata in accordance with an embodiment of the present invention; and

FIG. 7b is a flow chart illustrating the process of accessing images via a web server in accordance with an embodiment of the present invention.

### DETAILED DESCRIPTION OF THE INVENTION

Disclosed herein is a media distribution system which organizes media by time and geographic location, and enables event attendees to create a collection of media in real time that may be viewed or purchased immediately by all participants. Media includes but is not limited to photos, videos, or any other digital graphic presentation. Media collections automatically organize into logical events based on time and location, or may be defined by users in searches and event registrations, but do not require registration with an event or group. The media distribution system does not require a media sharing application for a source device, i.e. a camera phone or wireless camera, but a media sharing application may be utilized as well to better control the user experience.

The user taps a camera button on their source device to take a photograph or video (media). The user may then discard or save the media based on their satisfaction with the taken photograph or video. If the media is saved, a website uploads the media with its associated metadata to a digital media management and order server. Typical metadata includes but is not limited to: time, geographical data, and/or camera direction, angle, or focal length. The server and website are configured to display the uploaded media to other users of the media distribution system who were at the same event, i.e. in the same time and geographic location.

The web interface generally includes but is not limited to four main elements: a camera button to activate the camera, a search button to enable users to search for media by time and location, a “plus” button to produce additional options for entering more detailed search criteria, and the media most recently captured in that time and location. Media may be displayed on a small wireless device, such as a mobile device, or in a traditional browser on a tablet or computer screen. Media may be displayed in a horizontal or vertical stack that may be scrolled left/right or up/down respectively, either by touch, or with a mouse or trackpad as nonlimiting examples. Most recently captured media or media captured nearby a user's current location may appear at the top of the stack.

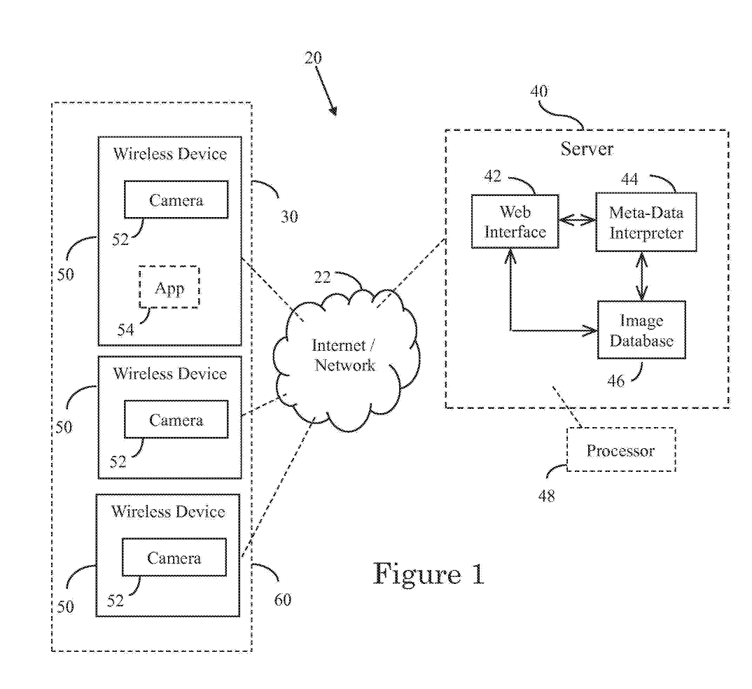

FIG. 1 is a block diagram of a digital media management system 20 in accordance with an embodiment of the present invention. The system 20 includes a network 22 coupled to a media management server 40 and plurality of wireless devices 50. According to some embodiments, network 22 may be implemented as a single network or a combination of multiple networks. Network 22 may include a wireless telecommunications network adapted for communication with one or more other communication networks, such as the internet. Network 22 may also include the internet, one or more intranets, landline networks, wireless networks, and other communication networks.

The server 40 includes a web interface component 42 configured to generate a web page and/or generally send and receive information to network 22 and a plurality of wireless devices 50. According to some embodiments, web interface component 42 includes a wireless communication component, such as a wireless broadband component, a wireless satellite component, or other types of wireless communication components including but not limited to radio frequency (RF), microwave frequency (MVF), or infrared (IR) components configured for communication with network 22. Web interface component 42 may also be configured to interface with a digital subscriber line (DSL) modem, a public switched telephone network (PSTN) modem, an Ethernet device, or various other types of wired or wireless communication devices adapted for communication with network 22.

The server 40 further includes a metadata interpreter 44 configured to receive metadata associated with each media and a media database 46 configured to store the media with their associated metadata. Metadata includes but is not limited to time, geographical data, and/or camera direction, angle, or focal length. The server 40 also includes one or more processors 48 capable of reading instructions stored on a non-transitory machine-readable media configured with any appropriate combination of hardware or software to implement the web interface component 42, metadata interpreter 44, and media database 46. Some common forms of machine-readable media include but are not limited to floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a processor or computer is adapted to read. The metadata interpreter 44 is generally configured to receive metadata for each image that is uploaded to the server 40 and vary the web interface 42 for each user based on certain user characteristics and the metadata associated with the media in the media database 46.

Digital media management system 20 includes a plurality of wireless devices 50. While FIG. 1 illustrates three wireless devices 50, it should be understood that the number of wireless devices or browsers may be varied without departing from the scope of the invention. Wireless device 50 may be a mobile device, such as a mobile phone, a smart phone, or a tablet computer as nonlimiting examples. Wireless device 50 may also be a processing device such as a personal computer, a personal digital assistant (PDA), or a notebook computer as nonlimiting examples. The plurality of wireless devices 50 generally include a camera 52 and may optionally include one or more applications 54. The camera 52 is typically a mobile phone camera or smartphone camera; however other cameras or media capturing technologies may be used as well provided the media is uploaded to the server 40 with the metadata intact. The camera 52 may use complementary metal oxide semiconductor (CMOS) image sensors, back side illuminated CMOS, or a charged coupled device (CCD) as nonlimiting examples. The plurality of wireless devices 50 also include one or more processors capable of reading instructions stored on a non-transitory machine-readable media configured with any appropriate combination of hardware or software to communicate with network 22. The plurality of wireless devices is generally located in a specific time and geographic location 60.

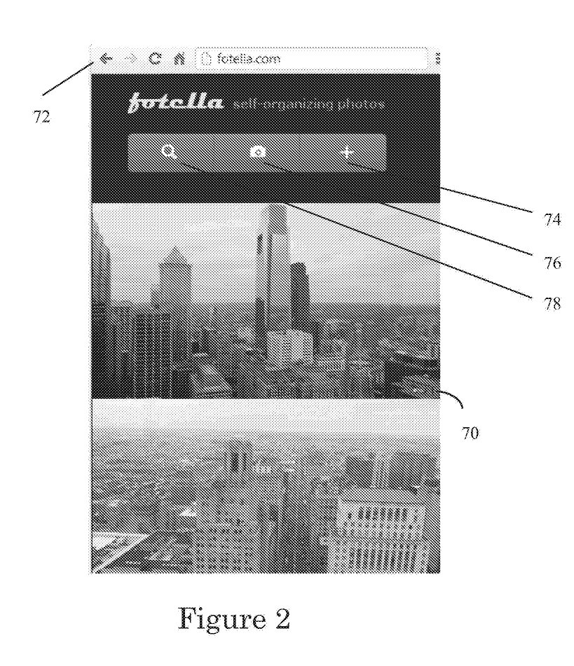

Referring now to FIG. 2, a sample home page of a web interface component 42 to the digital management system 20 is shown as it may appear on a wireless device 50. The system web interface 70 may be presented in the browser of the wireless device 50, displayed via a display component. The system web interface 70 may also be presented in a custom display through a user application. Display component may be a liquid crystal display (LCD) screen, an organic light emitting diode (OLED) screen, an active matrix OLED (AMOLED), an LED screen, a plasma display, or a cathode ray tube (CRT) display. The web interface 70 generally includes but is not limited to four main elements: a camera button 67 to activate the camera in the wireless device 50, a search button 78 to enable users to search for media by time and location, a “plus” button 74 to produce additional options for entering more detailed search criteria, and the media most recently captured in that time and location. The web page 70 interfaces via typical browser or user application controls 72. Controls 72 include an input component, which enables a user to input information into wireless device 50. In some embodiments, input component may include a keyboard or key pad. Controls 72 may also include a navigation control component, configured to enable a user using the device 50 to navigate along the display component. In some embodiments, navigation control component may be a mouse, a trackball, or other such device. In other embodiments, wireless device 50 includes a touchscreen such that display component, input component, and navigation control may be a single integrated component. Wireless device 50 may also utilize voice recognition technology for a user to interface with web page 70.

The “plus” button 74 links to additional system functions including but not limited to the following. A button to limit media shown to only the personal collection of a user, identified by a cookie on the wireless device 50 of the user. A “pin” button to display a map where media has been captured in a location range, whereby tapping on the map pins show media captured at that location. A “flag” button to mark inappropriate media in order to alert an event organizer or other moderator. A “sort” button in order to sort media by relevance, date, location range, views, or favorited media. For example, media may be sorted at a location so that those most frequently marked “favorite” display first, or display as first in the most recent media captured at that location.

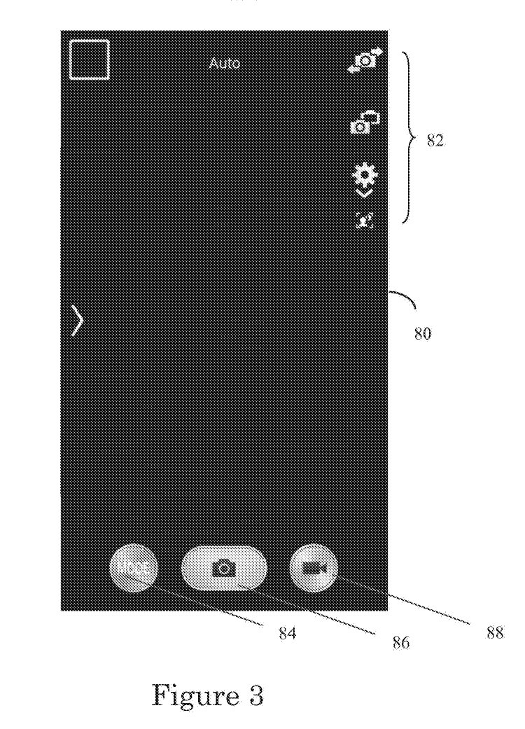

Referring now to FIG. 3, a sample screen shot 80 of a wireless device camera 52 before capturing media is shown. Operating in this mode, the wireless device 50 includes a plurality of camera controls 82. The display component will generally operate as a view finder allowing the user to preview the media for capture. In this nonlimiting example, the wireless device 50 includes a mode button 84 for choosing a camera operating mode, a shutter button 86 for capturing media, and a video/still camera select button 88 for selecting whether the camera captures photos or video. Camera modes include but are not limited to program mode, where the camera 52 automatically chooses aperture and shutter speed based on the amount of light that passes through the camera lens, shutter-priority mode, where the user manually sets the shutter speed of the camera 52 and the camera 52 automatically picks the right aperture based on the amount of light that passes through the camera lens, an aperture-priority mode, where the user manually sets the lens aperture and the camera 52 automatically picks the right shutter speed, and manual mode, where the user has full control of aperture and shutter speed.

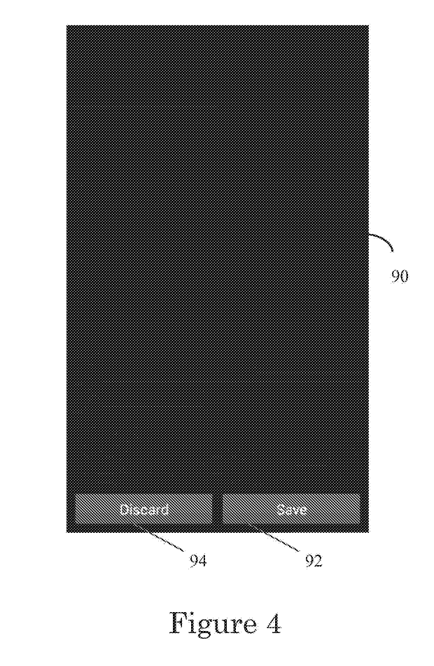

The user operates the shutter button 84 of the camera 52 to capture media. Once the media is captured, the system 20 presents the user with an approval screen 90, shown in FIG. 4. The approval screen 90 will generally allow the user to view the captured media and determine whether to approve or discard the media by tapping on the save button 92 or the discard button 94. If the user selects the discard button 94, the presently captured media is deleted and the wireless device 50 returns to the camera control screen 80 as shown in FIG. 3. If the user selects the save button 92, the media and its associated metadata are uploaded to the server 40. In some embodiments, the media may be resized prior to transmission to the server 40 to reduce upload times. The resizing/media size may be varied according to the speed of the data connection, and generally will become progressively larger over time as wireless transmission speeds increase.

Once the user selects the save button 92, the media and its associated metadata are uploaded to the server 40. The metadata generally includes the time the media was captured and location data along with other metadata available from the device 50 to the server 40. The server 40 stores the media and associated metadata in the media database 46. The server may store a large number of media in the database 46 and will use the associated metadata for each media to generate a display with a collection of images tailored for each user of the web site based on certain user information (such as a social media profile) as well as the metadata stored in the image database 46.

In addition to recently captured media, the server 40 may also link to feeds of media from other social media services. The media from other social media services and its associated metadata may be stored in the media database 46. This allows for a central database to store all media such that viewing collections can be accomplished through a single interface.

The meta-data interpreter 44 may be configured to generate a “Geo-Time-Hash” master index which may be stored on the server 40 in the media database 46. A Geo-Time-hash is a system for storing large amounts of data based on time and location, and making the large amounts of data quickly sortable and searchable. All media and its corresponding metadata may be stored in the Geo-Time-Hash master index. Slight changes to time or location change a hash, but since the hash is represented in big-endian format, the most significant bits of data are sorted first. This allows the system 20 to store 64̂11 unique time-location data points using a standard string of 14 characters. Most of this space will go unused because of gaps in time and location, but a busy location may handle many simultaneous media because of variation in location and time. Even in the case of a collision, the master index may find a hole for the media to allow it to be near its peers. The master index may also increase precision by lengthening the standard hash string by one character, which provides 64 times the precision when necessary. The hash may also be represented in little-endian or other formats as well without departing from the scope of the invention.

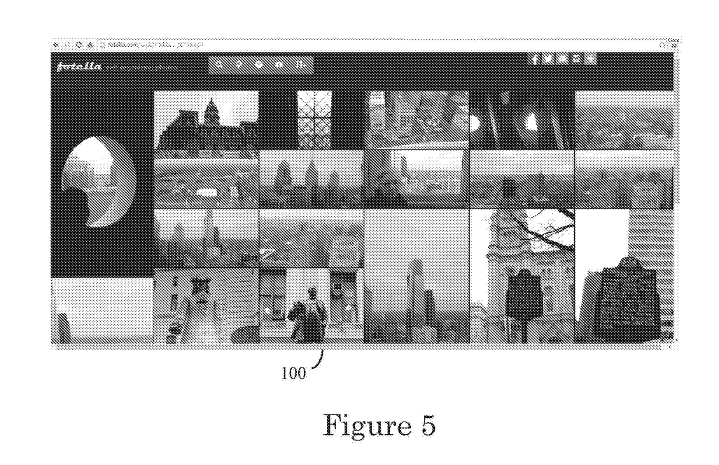

When a user arrives on a web page, the system 20 queries the wireless device 50 for time and location data. Referring now to FIG. 5, a sample screen shot 100 of the web interface component 42 is shown with search results on the web site as media expand to fill up a larger computer or tablet screen. If location data is available, the system 20 displays media recently taken in the same geography. This satisfies users who are at the same event and see media from other wireless devices 50 that are being captured at the event. For example, assume that the plurality of wireless devices 50 is located at a common geographic location and are generating media from the same general timeframe. These users are located generally in the same time and location 60 as shown in FIG. 1. When the system is accessed on a larger screen such as a computer or a tablet, the number of media shown may be expanded to fill the screen as shown in FIG. 5. Voice recognition technology may be utilized as well to assemble media from multiple social media feeds and display a collection of media to any addressable screen in response to voice commands.

The system 20 may include a natural grouping algorithm that enables the system 20 to automatically group media together and make predictions as to which media from different users might be from the same event. The system 20 may be configured to make suggestions as to which media comes closest in relation to other media or collections of media. The user may also correct the suggestions such that the system 20 can improve its predictions.

The system 20 may also generate a dynamic moving slideshow where a collection of media occurring in similar locations and times are grouped sequentially into a slideshow configured as a walk through the location. Media may be shown sequentially with a backdrop of the location. Each media may be positioned at the point and angle where it was captured, which is extrapolated from the location, angle, and focal length metadata recorded when the media was captured. Using this approach, the user is visually whisked from each media captured to the next.

At any time after an event or at a location distant from the event, a user may search for a specific time range and/or location range of an event. The time range may be for a period of hours or days as nonlimiting examples. In general, the user may specify the time range for the event as well as a location within a surrounding range to discover all media taken in that time and location. This functionality may be accessed using a search button 78 as shown in FIG. 2, or through voice recognition technology as well. A search may be saved and/or shared on other social media sites. The search may also become the default link for an event.

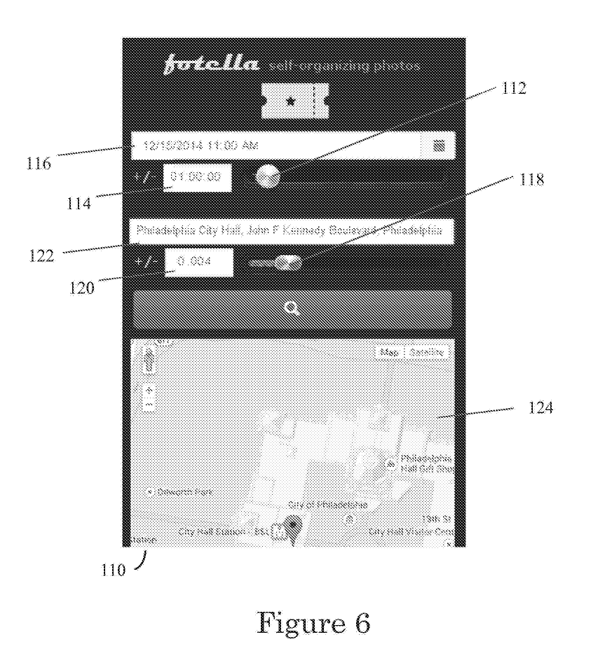

Referring now to FIG. 6, a sample screen shot 110 of a search page of the web interface component 42 is shown according to an embodiment of the present invention. In this nonlimiting example, sliders 112 and 118 are used to define the time range and location range to search, respectively. For instance, time slider 112 is used to adjust a time range 114 to search on either side of a central time 116. The location slider 118 is used to adjust a location range 120 on either side of a central location 122. The system 20 may also generate a graphical map display 124 representing the selected location range.

The system 20 may include facial recognition to further organize media and enable more sophisticated searches. Users who desire greater privacy may also blackout or blur their faces across the system 20. Media may be captioned with text or with voice captions spoken into a wireless device 50 and converted to text on the server 40. The system 20 may also document and promote local businesses and events by conveying hyperlocal advertising on the web interface 42 or wireless device 50.

The system 20 may further be configured to generate a time map, which shows an individual's movement over time and connecting locations where the individual took photos at specific times. For instance, a user's time map of a Saturday may show a pin on the Delaware River marked at 9 am connecting to a pin in Lambertville, N.J. marked 11:45 am, further connecting to a pin in New Hope, Pa. showing 1 pm, and further connecting to a pin in Philadelphia, Pa., showing 5 pm. Tapping on any pin may show the collection of media taken in that time and location. If a user attended a wedding at 1 pm, the user may tap on the pin in their time map to see the media at the wedding, instead of searching for the wedding.

An event organizer may register an event in the system 20 by naming the event, listing event attributes, and reserving the time and location. For instance, an event might be “the Johnson wedding at St. James Church 5185 Meeting Street, Charleston, S.C. on Jul. 14, 2015 at 2 p.m. for 2 hours on either side of the time, and 0.05 miles from the center of the location.” All media uploaded to the system 20 in that time and location range will be allocated to the event. The search page may also be represented as expanding circles on a map 124 with a secondary circle for time that expands and contracts as the user drags his or her finger on the screen of their wireless device 50.

Generally, building or venue owners may be given precedence in registering events. If they do not register events, then revenue may be shared with other event registrars. The event organizer may be allotted certain privileges such as an ability to remove unwanted media from the collection, although the unwanted media may still appear in a general search of the time and location range. The event organizer may also create products such as slide shows, books, and videos from the media, and may establish privacy by limiting viewing to certain audiences. Viewing may be limited to attendees who recorded media at the event, individuals within a particular social network, individuals with particular cellular phone numbers or email addresses, or any combination of the three as nonlimiting examples. An organizer who registers an event may name the event and receive a uniform resource locator (URL) or other type of uniform resource identifier (URI) to share. The URL that results from a search may also become a default link to a named event.

An event organizer or event owner may invite individuals to an event by email, text message, or through social media invites, and may send invitations to view event media to users who have expressed interest in the event or who were originally invited. Links to the event or event media may be shared on any social media service.

Users may find registered events by tapping on a ticket icon or another link displayed on the search screen 110, which produces a screen that list events near a time or location, or enables key word searches. Nonlimiting examples includes “Philadelphia on July 14”, “Johnson Wedding”, or “Philadelphia”.

Users may claim their media by registering their wireless device 50 with the system 20, or they may choose to remain anonymous. Users may find anonymity a benefit during social protests or simply because they do not want to be associated with their photos. By the terms of service, anonymous users may transfer their image ownership rights to the registered event owner, or in absence of a registered event, to the system 20. Users may share media or collections of media in the system 20 through popular social networks by tapping on icons that appears when inspecting media or when viewing search results. Outside of the system 20, users may share URL links to registered events or may copy URLs from the system search results.

The system 20 generally operates through cloud services as a virtual space that may sell a “time estate” whereby individuals who want oversight of an event may buy a time and location in order to acquire ownership of that event. The system 20 may also encourage registration of events by allocating a portion of profits from printing, advertising, or other revenue to event owners. When enough events are registered, the system 20 may publish a calendar of public events in a location range as a service for media creators and individuals seeking entertainment in an area. As nonlimiting examples, time estate may be sold under an auction model or bought as a blackout so all media taken in a certain time and location are either not accepted or blocked from public viewing.

The media and/or its corresponding metadata may be creatively used or re-used by professionals aiming to pull in user-sourced content accurate to the time and location. For instance, when creating a video from a live performance, an editor may access media from the system 20 that coincide with the timing of the professionally captured media of the event. A video could then be created from a compilation of fan-sourced media. The system 20 may be configured to manage media rights and acquisitions whereby performers or event owners may claim the right to content captured with their permission at the performance and the system 20 may share revenue with the performer or event owner.

The system 20 may include an application programming interface (API) to enable printing and photography/videography companies to accept orders for individual media or collections of media. The API may further enable stock photography counterparties to sell and/or license media for use in fine art, advertising, or other purpose, and to compensate media owners.

The system 20 may also be installed as an optional application 54 for a wireless device 50. The application 54 may be configured to capture media and upload them to the system 20 when a network connection becomes available. Media from digital cameras may also be uploaded to an event and the location data and time data modified to include that media at the event.

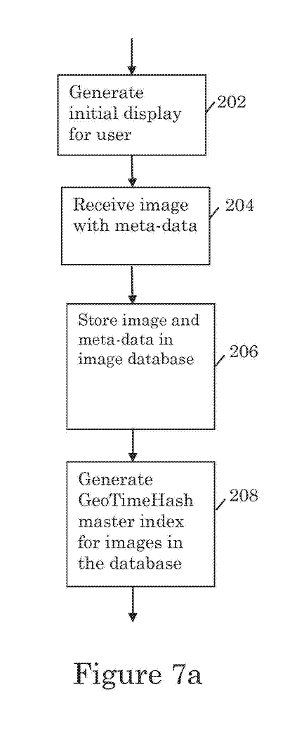

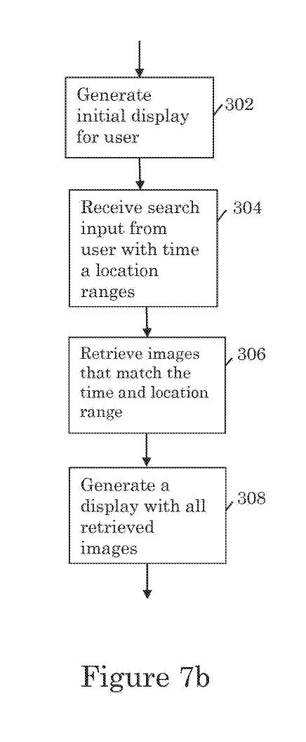

Referring now to FIG. 7a, a flow chart is shown illustrating the process of accumulating images and metadata in accordance with an embodiment of the present invention. It should be understood that any flowcharts contained herein are illustrative only and that other program entry and exit points, time out functions, error checking routines, and the like (not shown) would normally be implemented in a typical system software without departing from the scope of the invention. It is further understood that system software may run continuously after being launched such that any beginning and ending points are intended to indicate logical beginning and ending points of a portion of code that may be integrated with other portions of code and executed as needed. The order of execution of any of the blocks may also be varied without departing from the scope of the invention.

At step 202, the web server 40 generates an initial display screen for the user on their wireless device 50. The system 20 then receives media and its corresponding metadata from the wireless device 50 at step 204. The system then stores the media and its corresponding metadata in the media database 46 at step 206. When storing the media and metadata, the system 20 generates a Geo-Time-Hash master index for all media in the media database 46 in order to facilitate the process of subsequently displaying a collection of media to users via the web server 40.

Referring now to FIG. 7b, a flow is shown illustrating an example process of accessing images via a web server 40 according to an embodiment of the present invention. At step 302, the web server 40 generates an initial display screen for the user on their wireless device 50. The system 20 then receives a search input from the user at step 304. The search input generally includes a time and/or location range, but may include other inputs as well. The system 20 may also suggest inputs based on prior data retrieved from the user, for instance, if the system 20 determines that the user created a given event or was in attendance at a given event. The system 20 uses the Geo-Time-Hash master index to quickly retrieve the media that match the time and/or location range at step 306. The system 20 then presents the media to the user at step 308.

It is understood that the above-described embodiments are only illustrative of the application of the principles of the present invention. The present invention may be embodied in other specific forms without departing from its spirit or essential characteristics. All changes which come within the meaning and range of equivalency of the claims are to be embraced within their scope. Thus, while the present invention has been fully described above with particularity and detail in connection with what is presently deemed to be the most practical and preferred embodiment of the invention, it will be apparent to those of ordinary skill in the art that numerous modifications may be made without departing from the principles and concepts of the invention as set forth in the claims.

1. A digital media management system including a server configured to receive media from a plurality of wireless devices via a network, the server comprising:
a metadata interpreter configured to receive metadata associated with the received media, wherein the metadata comprises time and location data;
a media database configured to store a plurality of media and its associated metadata; and
a web interface component configured to automatically generate a display of media based upon time and location ranges corresponding to the associated metadata.

2. The system of claim 1, wherein the media database is configured to store media and corresponding metadata from a plurality of social media services.

3. The system of claim 1, wherein the web interface component is further configured to generate a display of media based upon user preferences.

4. The system of claim 1, wherein the wireless device comprises a camera.

5. The system of claim 4, wherein the associated metadata further comprises camera focal length.

6. The system of claim 1, wherein the web interface component is presented in a browser of the wireless device.

7. (canceled)

8. The system of claim 1, wherein the web interface component comprises:
a camera button to activate a camera in the wireless device;
a search button to enable users of the wireless device to search for media by time and location;
a plus button to produce additional options for more detailed search criteria; and
a display of recently captured media based upon the time and location of the wireless device.

9. The system of claim 8, wherein the plus button comprises:
a button to limit media shown to only the personal collection of the user of the wireless device;
a pin button to display a map where media has been captured in a location range;
a flag button to mark inappropriate media;
a sort button to sort media by relevance, date, location, views, or favorited media.

10. The system of claim 1, wherein the metadata interpreter is further configured to generate a Geo-Time-Hash master index based on time and location.

11. A method for digital media management comprising the steps of:
receiving media and associated metadata from a plurality of wireless devices, wherein the metadata comprises time and location data;
storing the plurality of media and its associated metadata in a database; and
automatically generating a display of media based upon time and location ranges corresponding to the associated metadata.

12. The method of claim 11, further comprising the presenting the display of media in a browser of the wireless device.

13. (canceled)

14. The method of claim 11, further comprising capturing media with a wireless device.

15. The method of claim 14, further comprising resizing the captured media prior to receiving the media.

16. The method of claim 11, further comprising searching for media based upon time and location ranges.

17. A digital media management system comprising:
a server configured for receiving media, the server comprising:
a metadata interpreter configured to receive metadata associated with the received media, wherein the metadata comprises time and location data; and
a media database configured to store a plurality of media and its associated metadata;
a plurality of wireless devices configured for transmitting media, each wireless device comprising:
a camera; and
a web interface component configured to automatically generate a display of media based upon time and location ranges corresponding to the associated metadata; and
a network for which to transmit and receive media.

18. The system of claim 17, wherein the associated metadata further comprises camera focal length.

19. The system of claim 17, wherein the web interface component is presented in a browser of the wireless device.

20. (canceled)

21. The system of claim 10, wherein the Geo-Time-Hash master index is represented in big-endian format.

22. The system of claim 17, wherein the metadata interpreter is further configured to generate a Geo-Time-Hash master index based on time and location.

23. The system of claim 17, wherein the Geo-Time-Hash master index is represented in big-endian format.
